(19) United States
(12) Patent Application Publication
(10) Pub. No.: US 2014/0116152 A1
(43) Pub. Date: May 1, 2014

(54) SYSTEM FOR DETERMINING AN ANGULAR POSITION

(71) Applicants: Joseph Wilson Johnston, Las Vegas, NV (US); Matthew John Volker, St. George, UT (US)

(72) Inventors: Joseph Wilson Johnston, Las Vegas, NV (US); Matthew John Volker, St. George, UT (US)

(21) Appl. No.: 13/666,073

(22) Filed: Nov. 1, 2012

(51) Int. Cl. G01N 3/20

(52) U.S. Cl. 73/849

(57) ABSTRACT

A system and method for determining an angular position of a spine of an elongated cylindrical object. The system includes a support structure configured to hold an elongated cylindrical object. The support structure includes a stop shaped and positioned to arrest and prevent lateral motion of an elongated cylindrical object beyond a predefined position. The support structure includes a first rotation facilitation device and a second rotation facilitation device configured to facilitate free rotation of an elongated cylindrical object about a long axis thereof. The system includes a weight configured to provide a consistent deflection force. The weight includes a third rotation facilitation device configured to facilitate free rotation of an elongated cylindrical object engaged therewith about a long axis thereof. The system includes a marking slot disposed through a surface of the support structure and configured to provide an aperture to mark an elongated cylindrical object.

### BACKGROUND OF THE INVENTION

1. Field of the Invention

The present invention relates to a system for determining an angular position, specifically to a system for determining an angular position of a spine of an elongated cylindrical object.

2. Description of the Related Art

An arrow is a shafted projectile that is shot with a bow. It predates recorded history and is common to most cultures. An arrow usually consists of a shaft with an arrowhead attached to the front end, with fletchings and a nock at the other end. The shaft is the primary structural element of the arrow, to which the other components are attached. Traditional arrow shafts are made from lightweight wood, bamboo or reeds, while modern shafts may be made from aluminum, carbon fiber reinforced plastic, or composite materials. Composite shafts are typically made from an aluminum core wrapped with a carbon fiber outer.

The stiffness of the shaft is known as its spine, referring to how little the shaft bends when compressed. Hence, an arrow which bends less is said to have more spine. Further, the stiffness of the spine of most arrows varies somewhat depending on what direction the arrow is bent. Accordingly shooting the same arrow from a bow but adjusting the nock and/or fletching so that the arrow is rotated when shot will generally result in different flight characteristics from those before the rotation.

In order to strike consistently, a group of arrows must be similarly spined. “Center-shot” bows, in which the arrow passes through the central vertical axis of the bow riser, may obtain consistent results from arrows with a wide range of spines. However, most traditional bows are not center-shot and the arrow has to deflect around the handle in the archer's paradox; such bows tend to give most consistent results with a narrower range of arrow spine that allows the arrow to deflect correctly around the bow. Higher draw-weight bows will generally require stiffer arrows, with more spine (less flexibility) to give the correct amount of flex when shot.

Some improvements have been made in the field. Examples of references related to the present invention are described below in their own words, and the supporting teachings of each reference are incorporated by reference herein:

U.S. Pat. No. 5,730,020, issued to Sullivan, discloses an apparatus for straightening arrowheads is designed to be used to straighten bent arrowheads so that the arrowheads, once straightened, may later be used in archery activities. To straighten a bent arrowhead, one removes or retracts any blades of the arrowhead (if possible) and attaches the arrowhead to a rotatable shaft. The rotatable shaft is free to rotate through the shaft aperture in the shaft housing, and the shaft housing is attached to the base of the device. To straighten the arrowhead, one applies pressure to the high side of the tip end of the arrowhead and, if desired, rotates the rotatable shaft so that the pressure is evenly applied to the high side of the tip end. The apparatus employs a pressure screw and a pressure band to effectively apply pressure to the arrowhead. After one or more applications of pressure to the high side of the tip end of the arrowhead, the arrowhead is checked to ensure that the arrowhead has the desired amount of straightness and that it is suitable for use in archery activities. Because straightening bent arrowheads while one is “in the field” is often desirable, the apparatus is compact and easily transportable.

U.S. Pat. No. 4,696,190, issued to Bucher et al., discloses a tube straightness checking apparatus includes a gauging mechanism disposed along a linear path and being operable to check the straightness of the tube as it is moved along the path past the mechanism. The gauging mechanism is operable to detect deviation of the tube from an imaginary centerline which is generally coincident with the linear path. The apparatus also includes linear hearing sets which guide a tube along the generally linear path past the gauging mechanism. Two embodiments of the gauging mechanism are disclosed. In the preferred embodiment, the gauging mechanism includes a gauge plate with a circular gauging orifice defined therein through which the tube passes as it is moved along the linear path. The gauge plate is electrically conductive and forms part of an electric circuit which is operable to provide an indication of an out-of-straightness condition upon the tube contacting the gauge plate as the tube moves along the linear path through the gauging orifice of the plate. In an alternative embodiment, the gauging mechanism includes a pair of orthogonally arranged analog proximity sensors disposed along the linear path and being operable to detect deviation of the tube from the imaginary centerline as the tube moves past the sensors along the linear path.

U.S. Pat. No. 4,623,410, issued to Hillesheim et al., discloses an arrow straightening machine which includes a nock or head alignment bearing attachment which allows for correction of any eccentricity or misaligmnent between the nock or head and the arrow shaft. The method discloses adhesively bonding the nock or head to the arrow shaft using the attachment device to align while the adhesive is in the unset condition.

U.S. Pat. No. 4,203,308, issued to Davis, discloses an arrow straightener for testing and straightening bent arrow shafts is provided with a pair of arrow supports, each of which has a bearing surface that is rotatable about an axis normal to a vertical plane through the longitudinal axis of an arrow positioned on the supports to maintain the bearing surface in flat contact relation to the arrow shaft, a press mechanism between the supports for applying a straightening pressure on the arrow shaft, and a deflection indicator with a feeler that extends through the press mechanism into contact with the shaft, the feeler being movable independent of the press but located at a point central to the pressure applying surface. The apparatus also includes a scale, indicator, weighted body, and spacer for testing the spine strength of wooden arrow shafts.

U.S. Pat. No. 4,155,172, issued to Bartol, discloses an arrow straightness gauge of this invention has an elongated body of a preselected length. A circular cross-sectional passageway traverses the entire length of the elongated body and provides openings at both ends of the elongated body. The aforementioned arrow shaft has a preselected diameter and a preselected length. The circular cross-sectional passageway is provided with an internal diameter greater than the arrow shaft diameter, such that when the arrow shaft is inserted axial through the circular cross-sectional passage there is established a diametral clearance between the arrow shaft to be tested and the internal diameter of the circular cross-sectional passageway. The circular cross-sectional passageway has a diameter equal to the arrow shaft diameter to be tested plus a measurement in the range of between 0.003 and 0.023 times the arrow shaft diameter to be tested. The elongated body of the arrow shaft straightness gauge has a length no less than 0.1 the arrow shaft length the straightness of which is to be tested. The elongated body of the gauge is fashioned of the same material composition as the arrow shaft to be tested.

The inventions heretofore known suffer from a number of disadvantages which include being limited in use, being difficult to use, being unable to locate a spine of an arrow, being bulky, being expensive, being unduly complex, being ineffective, being inefficient, being slow, not allowing a user to ‘feel’ the spine, being inaccurate, not being user friendly, being difficult to learn to use, being heavy, not being portable, requiring extensive setup time and/or effort, and requiring substantial expertise to operate.

What is needed is a system for determining an angular position of a spine of an elongated object that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available system for determining an angular position of a spine of an elongated object. Accordingly, the present invention has been developed to provide a simple and effective system and method of determining an angular position of a spine of an elongated object on an elongated cylindrical object.

According to one embodiment of the invention, there is a system for determining an angular position of a spine of an elongated cylindrical object. The system may include a support structure that may be configured to hold an elongated cylindrical object. The support structure may include a stop that may be shaped and positioned to arrest and prevent lateral motion of an elongated cylindrical object beyond a predefined position. The support structure may include a first rotation facilitation device that may be adjacent the stop, and may be orientated to functionally couple to an elongated cylindrical object that is engaged with the stop, and may be configured to facilitate free rotation of an elongated cylindrical object about a long axis thereof. The support structure may include a second rotation facilitation device that may be positioned distant from the stop, and may be orientated oppositely to the first rotation facilitation device and may be configured to operate as a deflection fulcrum and may facilitate free rotation of an elongated cylindrical object about the long axis. The support structure may be a sleeve. The support structure may include a pair of footing members that may be selectably coupleable to the support structure and may be configured to support the support structure in an angled position.

The system may include a weight that may be configured to provide a consistent deflection force. The weight may include a third rotation facilitation device configured to facilitate free rotation of an elongated cylindrical object that may be engaged therewith about the long axis thereof. The weight may include a base member that may have a flat bottom and may be configured to support the weight in an upright position.

The system may include a marking slot that may be disposed through a surface of the support structure and may be configured to provide an aperture to mark an elongated cylindrical object when engaged with the support structure. The system may include a nock tuner that may be coupled to the support structure, and may be extending therefrom and may be configured to engage with a nock of the elongated cylindrical object to permit a user to adjust the angular orientation thereof.

Each of the first, second and third rotation facilitation devices may be selected from the group of rotation facilitation devices consisting of bearing loaded wheels, belt-pulley systems, and paired bearings. The system may also include an elongated cylindrical object adjacent the stop and engaged with each of the first, second, and third rotation facilitation devices. The elongated cylindrical object may be an arrow.

According to one embodiment of the invention, there is a method for determining an angular position of a spine of an elongated cylindrical object. The method may include the step of inserting a first end of an elongated cylindrical object into a support structure. The method may include applying a weight to a second end of the elongated cylindrical object. The method may also include rotating the elongated cylindrical object about the support structure and the weight. The method may include the step of sensing/feeling for a spine of an elongated cylindrical object while rotation thereof. The method may further include marking the spine location of the elongated cylindrical object.

The step of inserting a first end of an elongated cylindrical object into a support structure may include the step of engaging the elongated cylindrical object with a first rotation facilitation device and a second rotation facilitation device of the support structure. The step of applying a weight to a second end of the elongated cylindrical object may include the step of engaging the second end of the elongated object with a third rotation facilitation device of the weight. The method for determining an angular position of a spine of an elongated cylindrical object may include the step of adjusting an angular orientation of the elongated cylindrical object with a nock tuner.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a side elevational view of a system for determining an angular position of a spine of an elongated object, according to one embodiment of the invention;

FIG. 2 is a perspective view of a support structure of a system for determining an angular position of a spine of an elongated object, according to one embodiment of the invention;

FIG. 3 is a front perspective view of a support structure of a system for determining an angular position of a spine of an elongated object, according to one embodiment of the invention;

FIG. 4 is a perspective view of a weight of a system for determining an angular position of a spine of an elongated object, according to one embodiment of the invention;

FIG. 5 is a cross-sectional view of a support structure of a system for determining an angular position of a spine of an elongated object having a deflected elongated cylindrical object extending out thereof, according to one embodiment of the invention;

FIG. 6 is a front elevational view of a weight of a system for determining an angular position of a spine of an elongated object, according to one embodiment of the invention; and

FIG. 7 is a flow chart of a method of determining an angular position of a spine of an elongated object, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

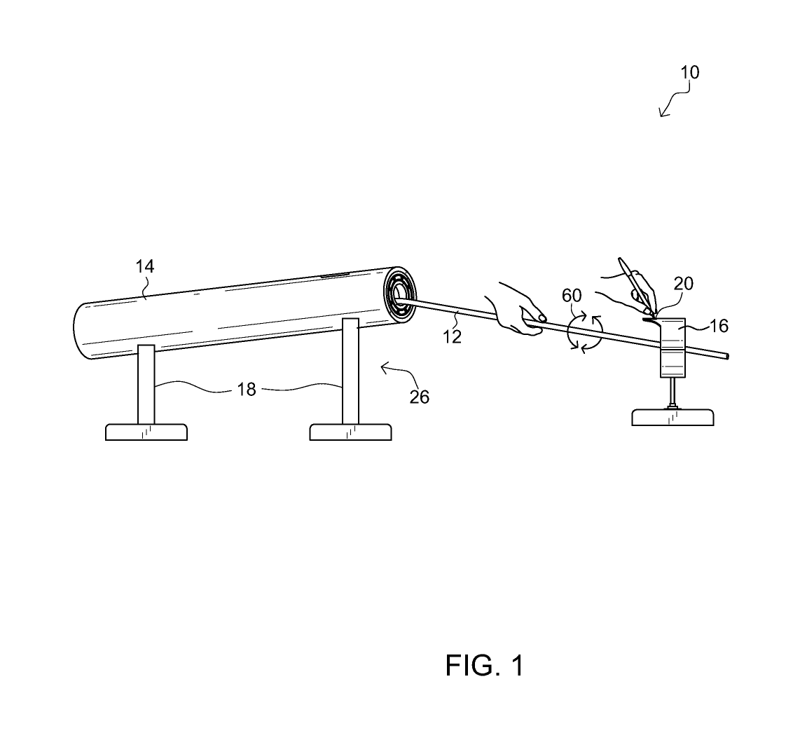

FIG. 1 is a side elevational view of a system for determining an angular position, according to one embodiment of the invention. There is shown a system for determining an angular position 10 of an elongated cylindrical object 12 including a support structure 12 and a weight 16. Such a system will generally be of most use when seeking a spine orientation of an elongated object having characteristics similar to an arrow shaft.

The illustrated system 10 is configured to determine an angular position of a spine of an elongated cylindrical object 12. The elongated cylindrical object 12 is an arrow. The system 10 includes a support structure 14 configured to hold the elongated cylindrical object 12 therein. The elongated cylindrical object 12 is configured to be disposed within the support structure, wherein the elongated cylindrical object 12 extends out from the support structure 14. The illustrated support structure 14 is a cylindrical sleeve and includes a pair of footing members 18 that may be selectably coupleable to the support structure 14 and/or to a surface such as but not limited to being bolted to a work table. The illustrated pair of footing members 18 are shaped and orientated to support the support structure 14 in an angled position 26. Such an angular position makes operation of the device more comfortable for the user and helps orient the elongated object at a higher vertical angle so that the weight is less likely to slide off the end.

The illustrated system 10 includes a weight member 16 configured to provide a consistent deflection force when the elongated cylindrical object 12 is rotated while pinned between the support structure 14 and the weight member 16. The weight includes a rotation facilitation structure that prevents the weight from impeding substantial free rotation of the elongated object.

The illustrated system 10 includes a marking slot 20 disposed through a hood of the weight 16 and configured to provide an aperture to mark a spine of the elongated cylindrical object 12 when engaged with the support structure 14 and the weight 16. Accordingly, once the spine of the elongated object has been found, the user may mark the elongated object and then remove the elongated object for further processing.

The illustrated system 10 is configured to enable a user to feel for a spine or a stiffest axis of the elongated cylindrical object 12. The elongated cylindrical object 12 is configured to be inserted into the support structure 14 to an end, wherein the elongated cylindrical object 12 extends out from the support structure 14. The end, opposite of the end disposed within the support structure 14, is configured to selectably engage the weight 16 about a top portion of the elongated cylindrical object 12. The user then rotates 60 the elongated cylindrical object 12 to feel for a spine of the elongated cylindrical object.

Such a system will generally be used when finding the spine of arrow shafts. Arrow shafts bend differently depending on the direction of the bend. This is generally caused by asymmetry in the construction of the arrow, including but not limited to arrow shafts constructed from graphite, carbon, and/or aluminum and/or combinations thereof. While well-constructed arrows have a smaller asymmetry, it is virtually impossible to consistently eliminate this asymmetry for manufactured arrows. This can impact the accuracy and consistency of the arrow when fired from a bow. Accordingly, participants in bow sports will often fletch their own arrows and knowing where the spine, or stiffest angular location, of the arrow shaft aids in selecting the best positions for the fletching.

In one non-limiting example there is a system that lets you to feel the spine or stiffest point of the shaft when you deflect it with a weight member. The system includes a sleeve and a corresponding weight member. The arrow slides into the sleeve and rests inside and the weight member is then placed towards the end of the arrow sticking out of the sleeve and rests against the top surface of that part of the arrow. The sleeve includes an end cap, a first bearing cylinder near the end cap, a second bearing cylinder near the mouth of the sleeve, and a nock tuner. There is a base that holds up the sleeve that may be a separate base or may just be footings that extend from the sleeve that may hold it at an angle and stay there as a user applies pressure during use. The weight member includes a weight and a third bearing cylinder extending from the weight/handle and may include a slot for marking arrows near the top of the bearing cylinder.

In operation, a user places the elongated object in the system. The elongated object will bend/deflect because of being pinned between the points of engagement. The user then uses their fingers to spin the elongated object about its long axis. Because the elongated object will generally deflect to a different degree depending on the angle of spin, the user will feel increased and decreased resistance to the spinning thereof. Since human hands have a very high density of nerve endings, the user is able to feel this resistance and the sensory experience translates to knowing where the spine is. While other systems use deflection to determine spine location, they generally provide deflection information in the form of a measurement on a gauge or dial. The present invention provides that information directly to the fingers of the user and thus makes the process more intuitive and visceral.

Since archery is inherently an intuitive and visceral process, the system and method described herein provides enhanced benefits when finding the spine of an arrow shaft. This is particularly true for aficionados who fletch their own arrows. Such individuals will often have favorite singular arrows that they intellectually and intuitively “know” to a high degree. Accordingly, such a system and method will advantageously increase a user's connection to their arrows and knowledge thereof at both an intellectual and intuitive level because they will be able to “feel” the spine of the arrow shaft.

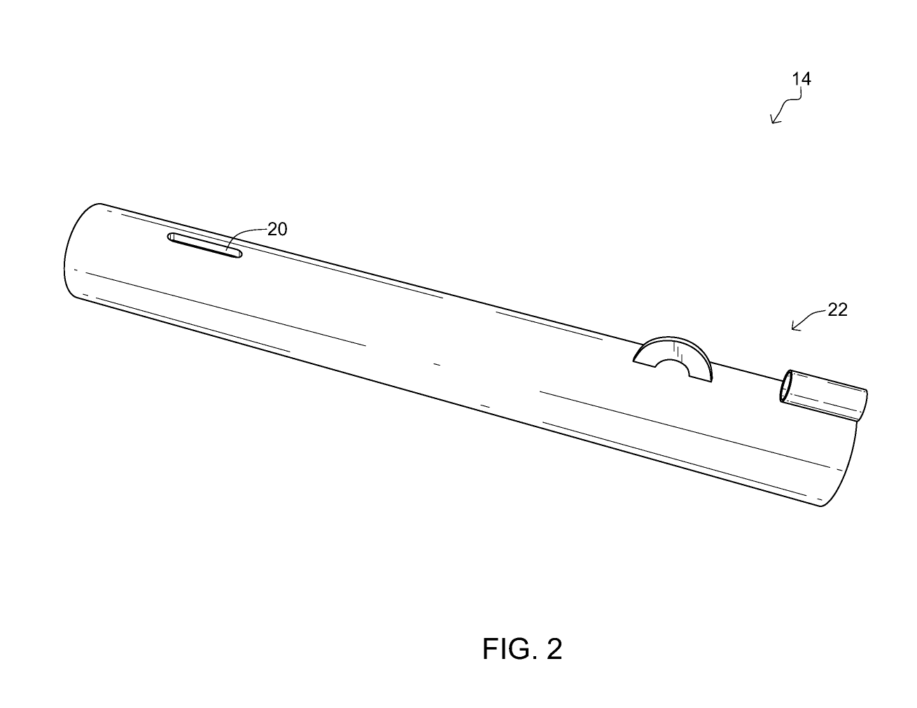

FIG. 2 is a perspective view of a support structure of a system for determining an angular position, according to one embodiment of the invention. There is shown a support structure 14 including a marking slot 20 and a nock tuner 22.

The illustrated support structure 14 is configured to hold an elongated cylindrical object, such as but not limited to an arrow or arrow shaft. Support structure 14 includes a marking slot 20 disposed through a top surface of the support structure 14. The marking slot 20 is configured to provide an aperture to mark a spine of an elongated cylindrical object when engaged with the support structure 14. It may be best that the marking slot be disposed on a top portion of a support structure for easy marking of the elongated object. Such a marking slot may be a marking guide structure wherein the support structure is not a cylinder and may include one or more guide rails configured to permit consistent marking of elongated objects from test to test. Such a marking slot/structure will permit a user to mark an elongated object with a marking tool, such as but not limited to a pencil, pen, marker, crayon, etc. as appropriate for the surface to be marked and the purposes of the marking thereof.

The illustrated support structure includes a nock tuner 22 coupled to a top surface the support structure 14. The nock tuner 22 is configured to extend from a top surface of the support structure 14 and configured to engage with a nock of an elongated cylindrical object to permit a user to adjust the angular orientation thereof.

In one non-limiting example optimized for use with arrow shafts, a support structure may be a tube between about 6-10 inches in length with bearing cylinders at both ends and an end cap closing off one of the ends.

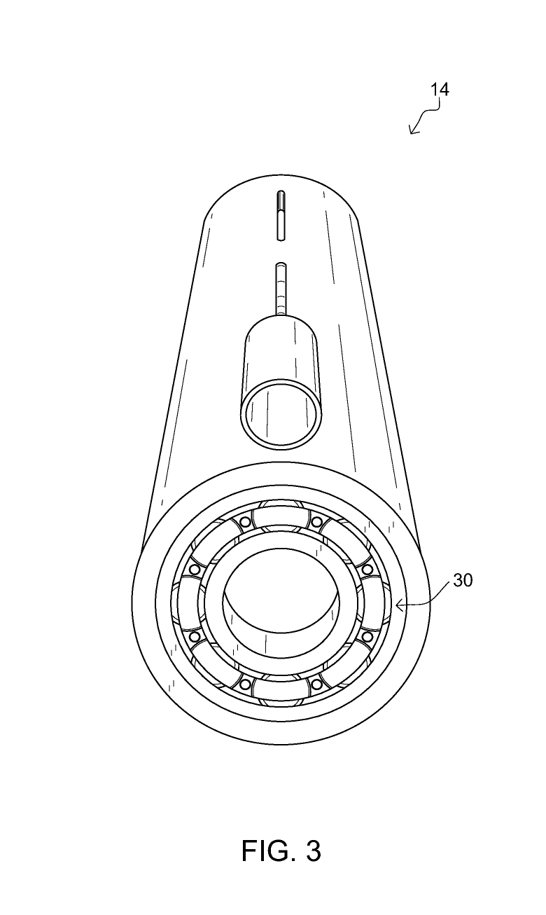

FIG. 3 is a front perspective view of a support structure of a system for determining an angular position, according to one embodiment of the invention. There is shown a support structure 14 including a second rotation facilitation device 30.

The illustrated support structure 14 is configured to hold and support an elongated cylindrical object when disposed therein. The support structure 14 includes a second rotation facilitation device 30 configured to operate as a deflection fulcrum. The second rotation facilitation device 30 is configured to facilitate free rotation of an elongated cylindrical object about a long axis thereof when rotated therefrom. The second rotation facilitation devices may be selected from the group of rotation facilitation devices consisting of bearing loaded wheels, belt-pulley systems, and paired bearings.

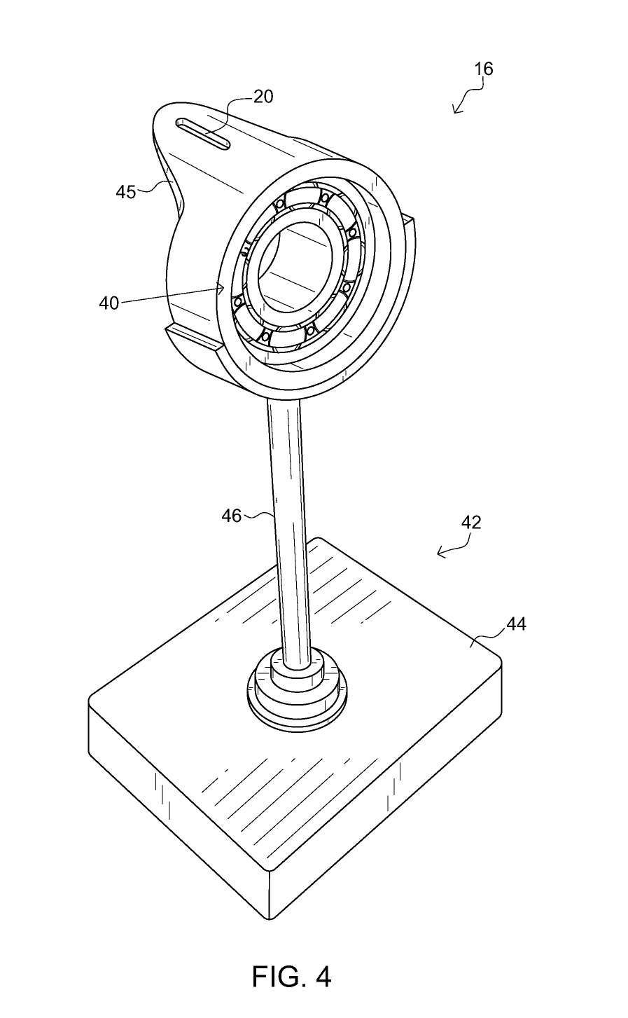

FIG. 4 is a perspective view of a weight of a system for determining an angular position, according to one embodiment of the invention. There is shown a weight 16 including a third rotation facilitation device 40, a base member 42, and a hood 45.

The illustrated weight 16 is configured to provide a consistent deflection force relative to an elongated cylindrical object extending from a support structure of a system for determining an angular position of a spine of an elongated cylindrical object. The weight 16 includes a third rotation facilitation device 40 configured to facilitate free rotation of an elongated cylindrical object when engaged therewith about a long axis thereof. The third rotation facilitation devices 40 may be selected from the group of rotation facilitation devices consisting of bearing loaded wheels, belt-pulley systems, and paired bearings. The weight 16 includes a base member 42 having a flat bottom 44 and a support arm 46 configured to support the weight 16 in an upright position.

The illustrated weight 16 includes a hood 45 extending out parallel from a top portion of weight 16. The hood 45 includes a marking slot 20 disposed through a top surface of the weight 16. The marking slot 20 is configured to provide an aperture to mark a spine of an elongated cylindrical object when engaged with a support structure and the weight 16. It may be best that the marking slot be disposed on a top portion of a weight for easy marking of the elongated object. Such a marking slot may be a marking guide structure wherein the weight is not a cylinder and may include one or more guide rails configured to permit consistent marking of elongated objects from test to test. Such a marking slot/structure will permit a user to mark an elongated object with a marking tool, such as but not limited to a pencil, pen, marker, crayon, etc. as appropriate for the surface to be marked and the purposes of the marking thereof.

In one non-limiting embodiment that may be optimized for spine-finding of arrows, a weight member may weigh between about 1-3 pounds and may include a footing at a bottom portion thereof such that when not in use it may be conveniently stored on a flat surface. The weight member may be shaped to include a handle (example, see illustrated) that a user may use when manipulating the weight member.

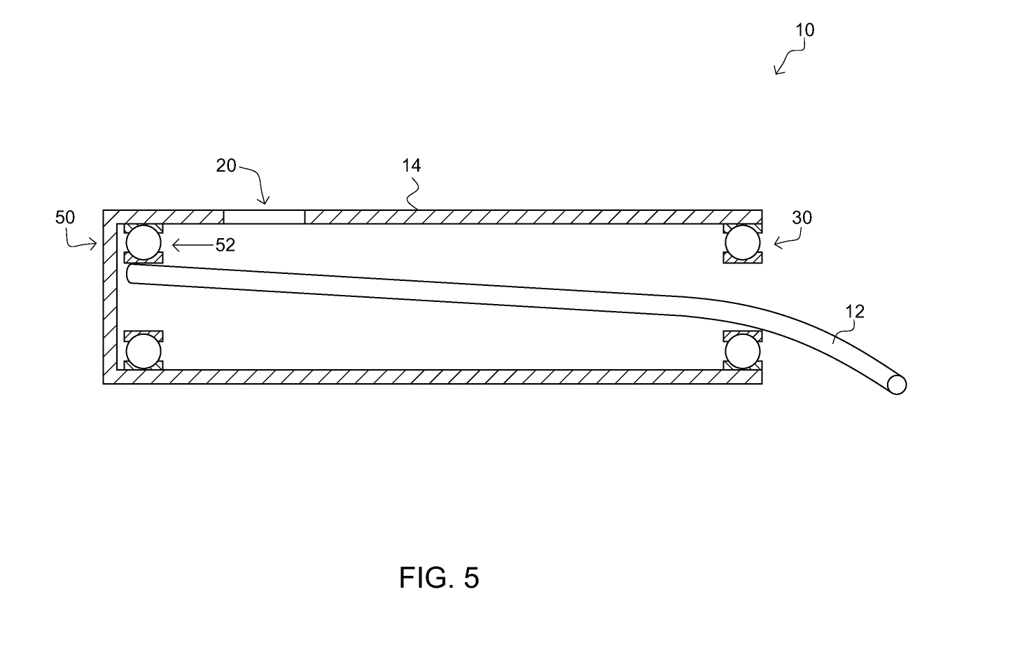

FIG. 5 is a cross-sectional view of a support structure of a system for determining an angular position having a deflected elongated cylindrical object extending out thereof, according to one embodiment of the invention. The deflection of the elongated cylindrical object is exaggerated for illustration purposes. There is shown an elongated cylindrical object 12 disposed within a support structure 14 including a stop 52, a first rotation facilitation device 52, a second rotation facilitation device 30, and a marking slot 20.

The illustrated system 10 is configured to determine an angular position of a spine of an elongated cylindrical object 12. The system 10 includes a support structure 14 is configured to hold and support the elongated cylindrical object 12. The support structure 14 includes a stop 50 shaped and positioned to arrest and prevent lateral motion of the elongated cylindrical object 12 beyond a predefined position. The support structure 14 includes a first rotation facilitation device 52 disposed adjacent the stop, and orientated to functionally couple to the elongated cylindrical object 12 that is engaged with the stop 50. The first rotation facilitation device 52 is configured to facilitate free rotation of the elongated cylindrical object 12 about a long axis thereof.

The illustrated support structure 14 includes a second rotation facilitation device 30 positioned distant from the stop 50, and orientated oppositely to the first rotation facilitation device 50. The second rotation facilitation device 30 is configured to operate as a deflection fulcrum and configured to facilitate free rotation of the elongated cylindrical object about a long axis. The support structure 14 includes a marking slot 20 disposed through a surface of the support structure 14 and configured to provide an aperture to mark a spine of the elongated cylindrical object 12 when engaged with the support structure 14. The first and second rotation facilitation devices may be selected from the group of rotation facilitation devices consisting of bearing loaded wheels, belt-pulley systems, and paired bearings.

The illustrated elongated cylindrical object 12 is configured to engage the first rotation facilitation device 52 about a top surface of the elongated cylindrical object 12 and also engage the second rotation facilitation device 30 about a bottom surface of the elongated cylindrical object 12. The elongated cylindrical object 12 is configured to flex to apply tension to engage the first and the second rotation facilitation devices 52, 30.

The illustrated system is configured to permit a user to find a spine of an elongated object. The illustrated system includes components of particular shapes and relative sizes and orientations. As an example, the stop and first and second rotation facilitation structures are housed in a cylindrical sleeve. However, the particular shape of “cylindrical sleeves” is not the only shape that could function. Such a system may have a great variety of shapes and sizes while still providing the structure needed to operate the method described herein. In particular, there are four points of engagement with an elongated object, including a stop and first, second and third rotation facilitation structures/devices. These four points of engagement with the elongated object are needed to generate the bend in the elongated object and allow the user to rotate the same while feeling for the spine. See FIGS. 1 and 4 for the third rotation facilitation device and how it engages with the elongated object. The stop prevents longitudinal motion of the elongated object (keeps the elongated object from going further into the structure) while the rotation facilitation devices permit the free rotation thereof along its long axis. In particular, when in use there is an elongated cylindrical object adjacent the stop and engaged with each of the first, second, and third rotation facilitation devices. Accordingly, devices of shapes other than those illustrated herein are contemplated herein.

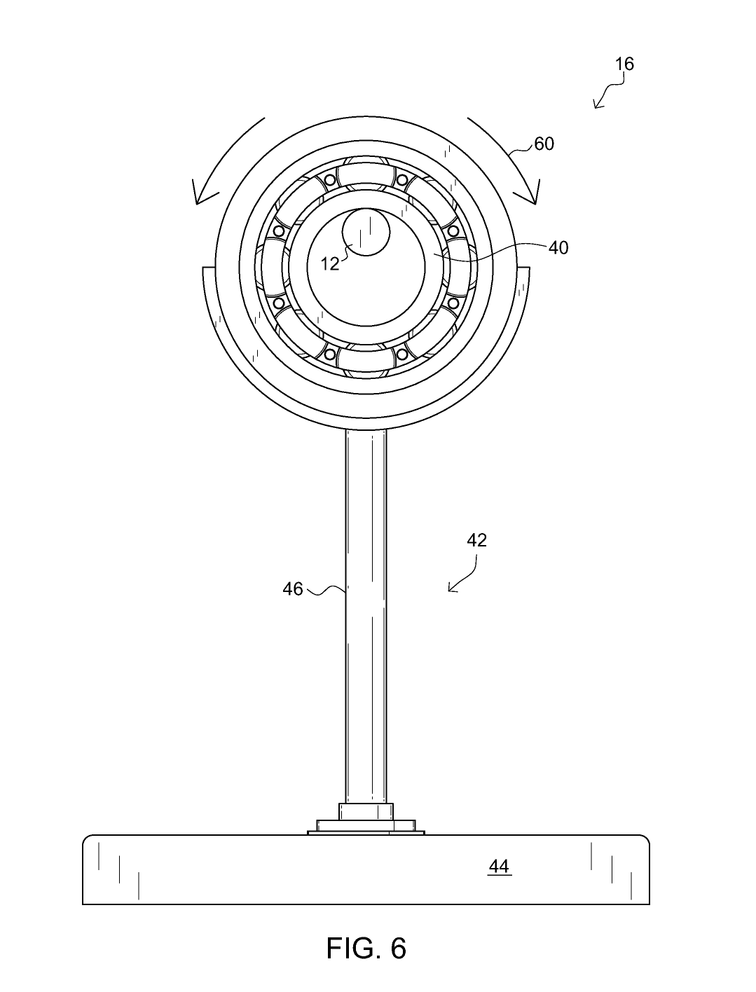

FIG. 6 is a front elevational view of a weight of a system for determining an angular position, according to one embodiment of the invention. There is shown an elongated cylindrical object 12 engaged with a third rotation facilitation device 40 of a weight 16.

The illustrated weight 16 is configured to provide a consistent deflection force relative to an elongated cylindrical object 12 extending out from a support structure of a system for determining an angular position of a spine of an elongated cylindrical object. The weight 16 includes a third rotation facilitation device 40 configured to facilitate free rotation of an elongated cylindrical object when engaged therewith about a long axis thereof. The third rotation facilitation devices 40 is configured to engage a top surface of the elongated cylindrical object 12. The weight 16 includes a base member 42 having a flat bottom 44 and a support arm 46 extending up therefrom. The base member 42 is configured to support the weight 16 in an upright position. The weight 16 may include a symmetrical balance or an asymmetrical balance.

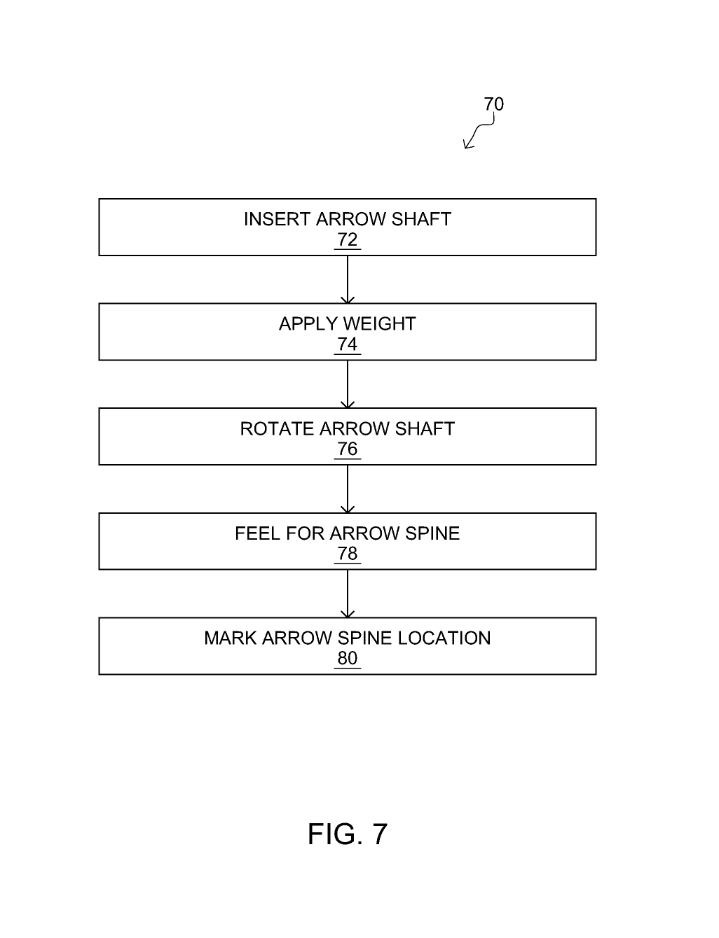

FIG. 7 is a flow chart of a method of determining an angular position, according to one embodiment of the invention. Also see FIG. 1 for a symbolic graphical representation of the method thereof. There is shown a method of determining an angular position of an elongated cylindrical object 70.

The illustrated method 70 is configured to determine an angular position of a spine of an elongated cylindrical object. The method 70 includes the step of inserting a first end of an elongated cylindrical object into a support structure 72. The step of inserting a first end of an elongated cylindrical object into a support structure 72 includes the step of engaging the elongated cylindrical object with a first rotation facilitation device and a second rotation facilitation device of the support structure.

The method 70 includes applying a weight to a second end of the elongated cylindrical object 74. The step of applying a weight to a second end of the elongated cylindrical object includes the step of engaging the second end of the elongated object with a third rotation facilitation device of the weight.

The method 70 also includes rotating the elongated cylindrical object about the support structure and the weight 76. The first, second, and third rotation facilitation devices are configured to enable the elongated cylindrical object to freely rotate therebetween.

The method 70 includes the step of sensing/feeling for a spine of an elongated cylindrical object during rotation thereof 78. The method 70 further includes marking the spine location of the elongated cylindrical object. The step of marking the spine location of the elongated cylindrical object includes the step of inserting a marking device into a marking slot of the support structure and marking the elongated cylindrical object.

The method for determining an angular position of a spine of an elongated cylindrical object 70 includes the step of adjusting an angular orientation of the elongated cylindrical object with a nock tuner.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the illustrated stop is an end cap, it may be embodied as a flange, cone, a tab, a mesh screen, a post, a specially configured vise/clamp and the like or any other structure configured to prevent longitudinal motion of the elongated object while not interfering with the rotational motion thereof.

Additionally, although the figures illustrate the support structure described herein as a solid opaque cylindrical sleeve, such may be embodied in other structures, including but not limited to sleeves of non-circular cross-section, sleeves that are straight and/or curved, sleeves that are transparent/translucent, mesh sleeves, flexible sleeves, and even structures that are not sleeves but that provide the necessary structural support for the components described herein so that their relative positions are fixed as needed to perform the method described herein.

It is also envisioned that rotation facilitation structures may be different from the illustrated bearing cylinders described herein and may include belts, pulley systems, pairs adjacent bearings, greased surfaces, and the like and combinations thereof such that an elongated object engaged therewith may be locked into a particular vertical position (thus effectuating a bend) while permitting substantial free rotation of the same such that a user is able to feel the spine during operation of the method described herein.

It is expected that there could be numerous variations of the design of this invention. An example is that the weight member illustrated herein has a particular shape, orientation, symmetry, and the like. However, the shape/orientation/aesthetic configurations of the weight that include a weight coupled to a rotation facilitation device are plethoric.

Finally, it is envisioned that the components of the device may be constructed of a variety of materials, including but not limited to plastics, metals, ceramics, woven materials, fibers, composites, and the like and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A system for determining an angular position of a spine of an elongated cylindrical object, comprising:
a) a support structure configured to hold an elongated cylindrical object, the support structure including:
a1) a stop shaped and positioned to arrest and prevent lateral motion of an elongated cylindrical object beyond a predefined position;
a2) a first rotation facilitation device adjacent the stop, orientated to functionally couple to an elongated cylindrical object that is engaged with the stop, and configured to facilitate free rotation of an elongated cylindrical object about a long axis thereof; and
a3) a second rotation facilitation device positioned distant from the stop, orientated oppositely to the first rotation facilitation device and configured to operate as a deflection fulcrum and to facilitate free rotation of an elongated cylindrical object about the long axis; and
b) a weight configured to provide a consistent deflection force and including a third rotation facilitation device configured to facilitate free rotation of an elongated cylindrical object engaged therewith about the long axis thereof.

2. The system of claim 1, wherein the weight includes a base member having a flat bottom and configured to support the weight in an upright position.

3. The system of claim 1, wherein the support structure is a sleeve.

4. The system of claim 1, wherein each of the first, second and third rotation facilitation devices are selected from the group of rotation facilitation devices consisting of bearing loaded wheels, belt-pulley systems, and paired bearings.

5. The system of claim 1, further comprising a marking slot disposed through a surface of the support structure and configured to provide an aperture to mark an elongated cylindrical object when engaged with the support structure.

6. The system of claim 1, further comprising a nock tuner coupled to the support structure, extending therefrom and configured to engage with a nock of the elongated cylindrical object to permit a user to adjust the angular orientation thereof.

7. The system of claim 1, wherein the support structure further comprises a pair of footing members selectably coupleable to the support structure and configured to support the support structure in an angled position.

8. The system of claim 1, further comprising an elongated cylindrical object adjacent the stop and engaged with each of the first, second, and third rotation facilitation devices.

9. The system of claim 8, wherein the elongated cylindrical object is an arrow.

10. A method for determining an angular position of a spine of an elongated cylindrical object, comprising the steps of:
a) inserting a first end of an elongated cylindrical object into a support structure;
b) applying a weight to a second end of the elongated cylindrical object;
c) rotating the elongated cylindrical object about the support structure and the weight;
d) sensing/feeling for a spine of an elongated cylindrical object while rotation thereof; and
e) marking the spine location of the elongated cylindrical object;

11. The method of claim 10, wherein the step of inserting a first end of an elongated cylindrical object into a support structure includes the step of engaging the elongated cylindrical object with a first rotation facilitation device and a second rotation facilitation device of the support structure.

12. The method of claim 10, wherein the step of applying a weight to a second end of the elongated cylindrical object includes the step of engaging the second end of the elongated object with a third rotation facilitation device of the weight.

13. The method of claim 10, further comprising the step of adjusting an angular orientation of the elongated cylindrical object with a nock tuner.

14. A system for determining an angular position of a spine of an elongated cylindrical object, comprising:
a) a support structure configured to hold an elongated cylindrical object, the support structure including:
a1) a stop shaped and positioned to arrest and prevent lateral motion of an elongated cylindrical object beyond a predefined position;
a2) a first rotation facilitation device adjacent the stop, orientated to functionally couple to an elongated cylindrical object that is engaged with the stop, and configured to facilitate free rotation of an elongated cylindrical object about a long axis thereof; and
a3) a second rotation facilitation device positioned distant from the stop, orientated oppositely to the first rotation facilitation device and configured to operate as a deflection fulcrum and to facilitate free rotation of an elongated cylindrical object about the long axis; wherein the support structure is a sleeve; wherein the support structure further comprises a pair of footing members selectably coupleable to the support structure and configured to support the support structure in an angled position;
b) a weight configured to provide a consistent deflection force and including a third rotation facilitation device configured to facilitate free rotation of an elongated cylindrical object engaged therewith about the long axis thereof; wherein the weight includes a base member having a flat bottom and configured to support the weight in an upright position;
c) a marking slot disposed through a surface of the support structure and configured to provide an aperture to mark an elongated cylindrical object when engaged with the support structure; and
d) a nock tuner coupled to the support structure, extending therefrom and configured to engage with a nock of the elongated cylindrical object to permit a user to adjust the angular orientation thereof.

15. The system of claim 14, wherein each of the first, second and third rotation facilitation devices are selected from the group of rotation facilitation devices consisting of bearing loaded wheels, belt-pulley systems, and paired bearings.

16. The system of claim 15, further comprising an elongated cylindrical object adjacent the stop and engaged with each of the first, second, and third rotation facilitation devices.

17. The system of claim 16, wherein the elongated cylindrical object is an arrow.
